(19) United States
(12) Patent Application Publication
(10) Pub. No.: US 2025/0379014 A1
(43) Pub. Date: Dec. 11, 2025

(54) MAGNETICALLY OPERATED SWITCH STRUCTURE FOR RELAY

(71) Applicant: Sung-Jen Wu, New Taipei City (TW)

(72) Inventor: Sung-Jen Wu, New Taipei City (TW)

(21) Appl. No.: 18/733,889

(22) Filed: Jun. 5, 2024

(51) Int. Cl. H01H 50/18

(52) U.S. Cl. CPC H01H 50/18

(57) ABSTRACT

The present invention relates to a magnetically operated switch structure for a relay. The magnetically operated switch structure is installed inside the delay and adjacent to a coil set, into which a movable iron core is inserted, and comprises: a switch assembly, a lower magnetic motion assembly and an upper magnetic motion assembly. By operation between powered and unpowered states of the coil set, the movable iron core is driven to move up and down, causing displacement of the upper magnetic motion assembly. This displacement changes the distance between the upper and lower magnetic motion assemblies and causes a variation in a magnetic force between the upper and lower magnetic motion assemblies, thereby controlling opening and closing of the switch assembly. This eliminates excessive mechanical mechanisms, saving costs for manufacturers, and making production, maintenance, and repair processes easier and simpler.

### BACKGROUND OF THE INVENTION

### Fields of the Invention

The present invention relates to a magnetically operated switch structure for a relay and, more particularly, to a technique applied in the field of relays.

### Descriptions of Related Art

One type of relay uses the principle of magnetic attraction and repulsion of dual magnets to switch. As shown in FIG. 14, the dual magnets 4 are spaced from each other by a vertical distance, and the switch 5 is located between the dual magnets 4. When the upper magnet 4 moves away from the lower magnet 4, the switch 5 is not affected by magnetism, causing no motion. However, when the upper magnet 4 approaches the lower magnet 4, the switch 5 is opened under magnetism influence (the solid arrow indicates the movement direction of the upper magnet 4, and the dashed arrow indicates the direction of switch 5 opening). However, such a relay has a problem: when the switch 5 is subjected to the magnetism influence of the upper and lower magnets 4 for a long time, the switch 5, also made of metal, gradually becomes magnetized, eventually losing its ability to be attracted by the upper and lower magnets 4, or both ends of the switch 5 are deformed due to long-term magnetic attraction by the upper and lower magnets 4, causing fatigue in the metal parts of the switch 5 and ultimately leading to incomplete closure.

### SUMMARY OF THE INVENTION

In order to achieve the aforementioned objectives and effects, the present invention provides a magnetically operated switch structure for a relay. The magnetically operated switch structure is configured to be installed inside the delay and adjacent to a coil set, into which a movable iron core is inserted, and comprises: a switch assembly, that corresponds to one end of the movable iron core inserted into the coil set and is located below the coil set; a lower magnetic motion assembly, that is located between the switch assembly and the movable iron core and connected to the switch assembly; and an upper magnetic motion assembly, that is sleeved around one end of the movable iron core, spaced from the lower magnetic motion assembly by a gap and configured to be in magnetic effect with the lower magnetic motion assembly. By operation between powered and unpowered states of the coil set, the movable iron core is driven to move up and down, causing displacement of the upper magnetic motion assembly, and the displacement of the upper magnetic motion assembly changes a distance from the lower magnetic motion assembly and causes a variation in a magnetic force between the upper magnetic motion assembly and the lower magnetic motion assembly, thereby controlling opening and closing of the switch assembly.

### BRIEF DESCRIPTION OF THE DRAWINGS

FIG. 1 is a perspective schematic view of the first embodiment of the present invention.

FIG. 2 is an exploded perspective schematic view of the first embodiment of the present invention.

FIG. 3 is a detailed exploded perspective schematic view of FIG. 2.

FIG. 4 is a perspective schematic view from another angle of the switch assembly of FIG. 2 in.

FIG. 5 is a cross-sectional schematic view taken along the line V-V of FIG. 1 for illustrating an operational state in which the upper magnetic motion assembly and the lower magnetic motion assembly are in magnetic repulsion configuration, and the coil set is in unpowered state with no motion of the movable iron core, and the lower magnetic motion assembly pushes against the spring plate to cause the spring plate to store elastic energy and contact the positioning contact.

FIG. 6 is a cross-sectional schematic view for illustrating an operational state in which the coil set of FIG. 5 is powered, causing movement of the movable iron core and the upper magnetic motion assembly to control the operation of the switch assembly, allowing the spring plate of the switch assembly to elastically return and move away from the positioning contact.

FIG. 7 is a cross-sectional schematic view in accordance with the second embodiment of the present invention for illustrating an operational state in which the upper magnetic motion assembly and the lower magnetic motion assembly are in magnetic repulsion configuration, and the coil set is in unpowered state with no motion of the movable iron core, and the lower magnetic motion assembly pushes against the spring plate to cause the spring plate to store elastic energy and move away from the positioning contact.

FIG. 8 is a cross-sectional schematic view for illustrating an operational state in which the coil set of FIG. 7 is powered, causing movement of the movable iron core and the upper magnetic motion assembly to control the operation of the switch assembly, allowing the spring plate of the switch assembly to elastically return and contact the positioning contact.

FIG. 9 is a perspective schematic view of another embodiment of the lower bracket of the present invention.

FIG. 10 is a cross-sectional schematic view in accordance with the third embodiment of the present invention for illustrating an operational state in which the upper magnetic motion assembly and the lower magnetic motion assembly are in magnetic attraction configuration, and the coil set is in unpowered state with no motion of the movable iron core, and the lower magnetic motion assembly causes one end of the spring plate with the movable contact to deform, store elastic energy and move away from the positioning contact.

FIG. 11 is a cross-sectional schematic view for illustrating an operational state in which the coil set of FIG. 10 is powered, causing movement of the movable iron core and the upper magnetic motion assembly to allow one end of the spring plate with the movable contact to return and contact the positioning contact.

FIG. 12 is a cross-sectional schematic view in accordance with the fourth embodiment of the present invention for illustrating an operational state in which the upper magnetic motion assembly and the lower magnetic motion assembly are in magnetic attraction configuration, and the coil set is in unpowered state with no motion of the movable iron core, and the lower magnetic motion assembly causes one end of the spring plate with the movable contact to deform, store elastic energy and contact the positioning contact.

FIG. 13 is a cross-sectional schematic view for illustrating an operational state in which the coil set of FIG. 12 is powered, causing movement of the movable iron core and the upper magnetic motion assembly to allow one end of the spring plate with the movable contact to return and move away from the positioning contact.

FIG. 14 is an internal schematic view of a conventional relay.

### DETAILED DESCRIPTION OF THE PREFERRED EMBODIMENT

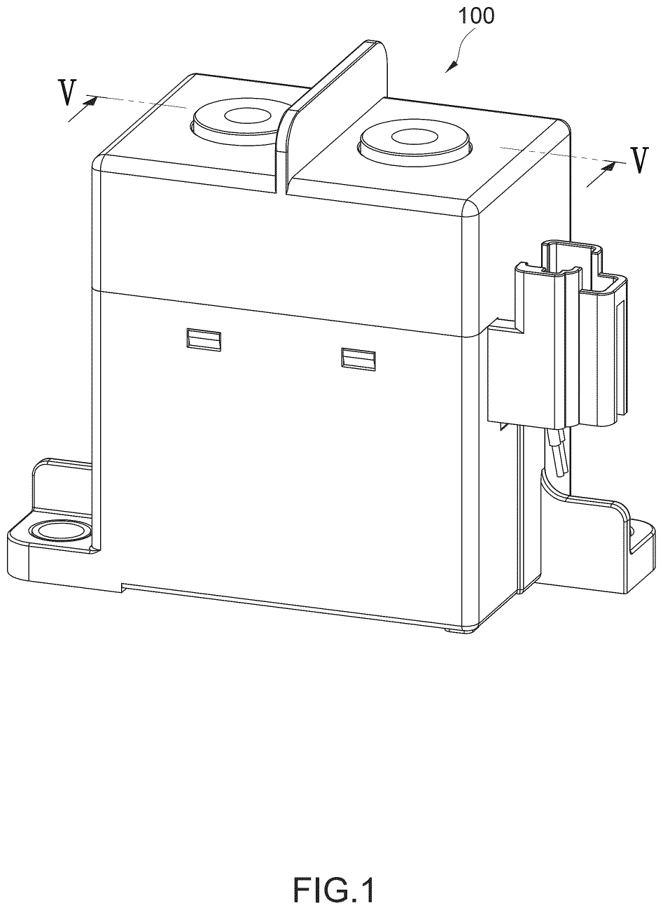

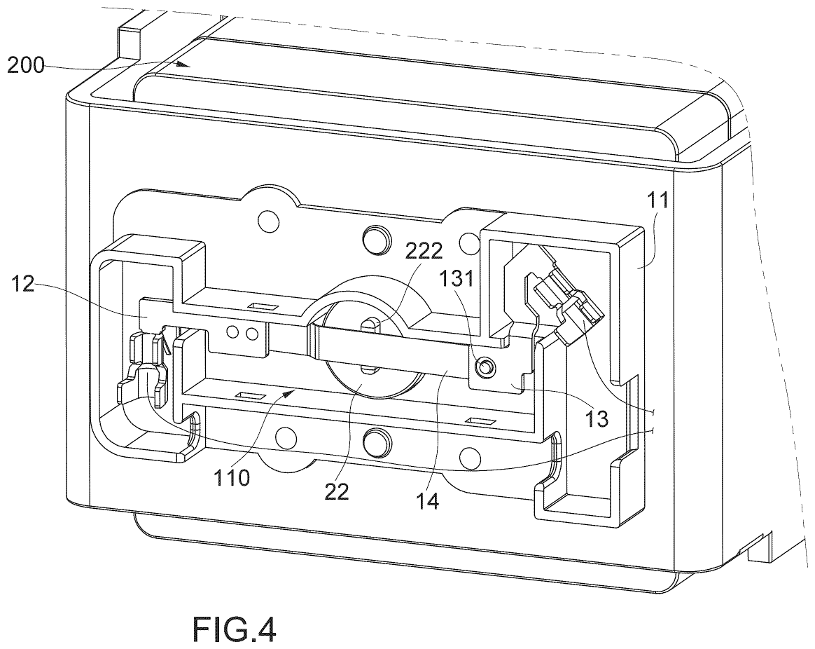

Referring to FIGS. 1 to 12, the present invention relates to a magnetically operated switch structure for a relay, which is installed inside a relay 100 and adjacent to a coil set 200. Additionally, a movable iron core 300 is movably inserted into the coil set 200. The present invention mainly provides two primary embodiments (distinguished by magnetic attraction and magnetic repulsion). In the first embodiment, please referring to FIGS. 1 to 6, the magnetically operated switch structure includes: a switch assembly 1 disposed inside the relay 100, corresponding to one end of a movable iron core 300 inserted into the coil set 200 and located below the coil set 200; a lower magnetic motion assembly 2, located between the switch assembly 1 and the movable iron core 300 and configured to make movable contact with the switch assembly 1; and an upper magnetic motion assembly 3, sleeved around one end of the movable iron core 300, spaced from the lower magnetic motion assembly 2 by a gap and configured to be in magnetic repulsion from the lower magnetic motion assembly 2. By the operation between powered and unpowered states of the coil set 200, the movable iron core 300 is driven to move up and down, causing displacement of the upper magnetic motion assembly 3. The displacement of the upper magnetic motion assembly 3 changes the distance from the lower magnetic motion assembly 2 and causes a variation in the repulsive force between the upper magnetic motion assembly 3 and the lower magnetic motion assembly 2, thereby controlling the opening and closing of the switch assembly 1.

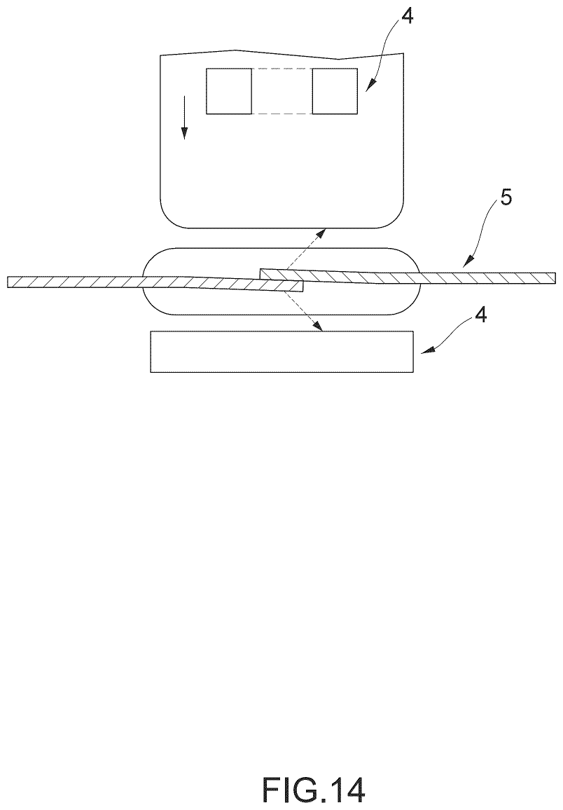

The relay 100 is equipped with the switch assembly 1, the lower magnetic motion assembly 2 and the upper magnetic motion assembly 3 therein and utilizes the principle of generating an electromagnetic field between the coil set 200 and the movable iron core 300 when powered, which drives the movement of the upper magnetic motion assembly 3. Through alteration in the distance between the upper magnetic motion assembly 3 and the lower magnetic motion assembly 2, the magnetic repulsive force between them varies accordingly, further controlling the switch assembly 1 to switch between on and off states. Additionally, in the present invention, the switch assembly 1 is disposed below the lower magnetic motion assembly 2, ensuring that there is no interference in the magnetic force between the upper magnetic motion assembly 3 and the lower magnetic motion assembly 2. As such, the switch assembly 1 can be effectively operated by the lower magnetic motion assembly 2 without being influenced by magnetic forces from both top and bottom, as shown in FIG. 14.

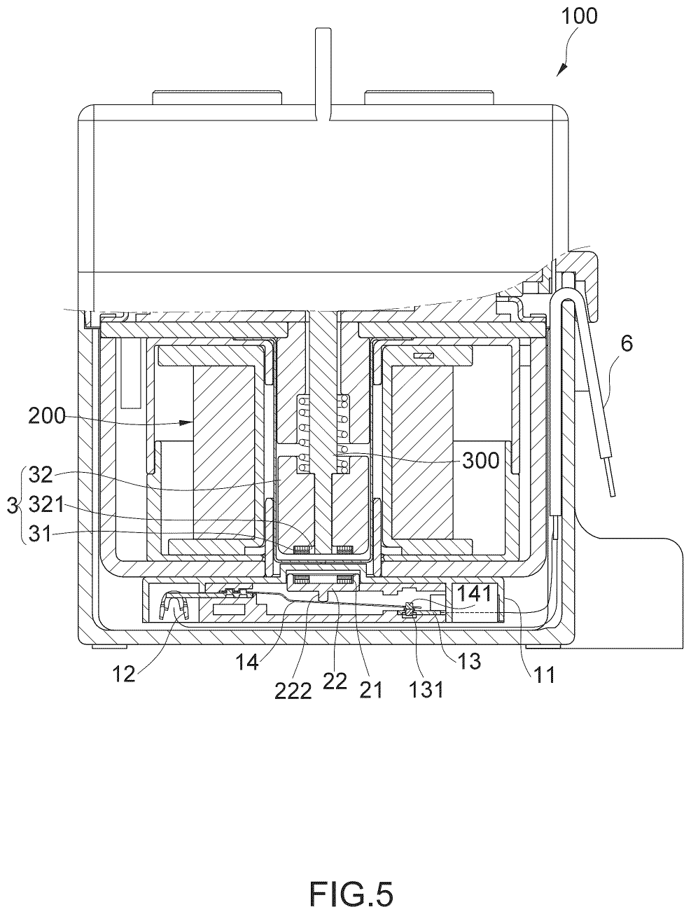

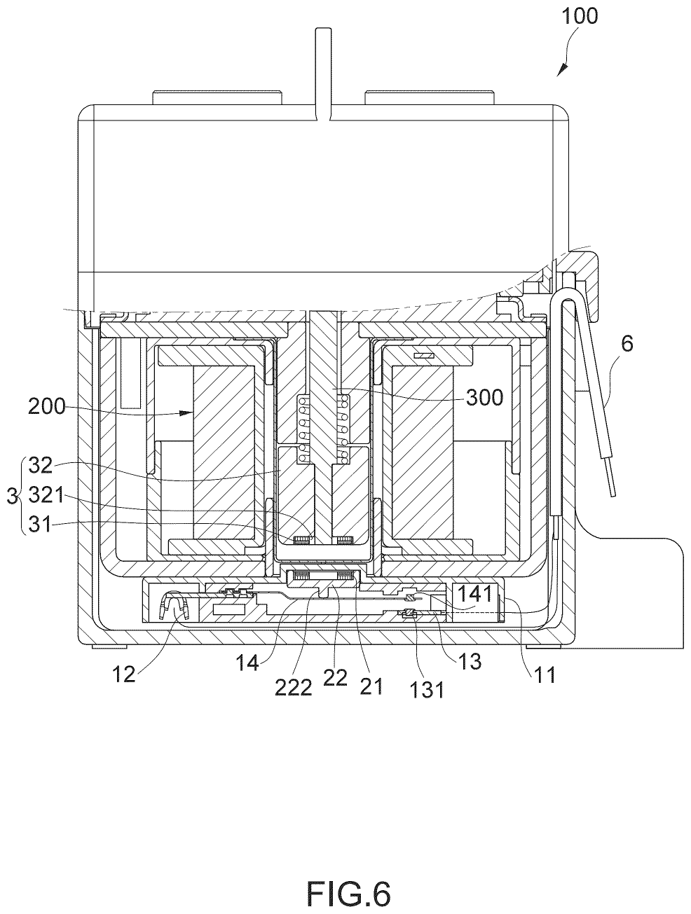

In the mode of the upper magnetic motion assembly 3 and the lower magnetic motion assembly 2 being magnetically repulsive, the switch assembly 1 further includes a base 11, a first terminal connector 12, a second terminal connector 13, and a spring plate 14. The base 11 is installed inside the relay 100 and abuts against the bottom surface of the coil set 200. A limiting groove 110 is recessed into the bottom surface of the base 11. The first terminal connector 12 and the second terminal connector 13 are installed at the opposite ends of the limiting groove 110, respectively. The spring plate 14 has one end electrically connected to the first terminal connector 12 and the other end provided with a movable contact 141 in movable contact with a positioning contact 131 of the second terminal connector 13. For two embodiments, the positioning contact 131 of the second terminal connector 13 can be disposed above or below the elastically swinging end of the spring plate 14. As shown in FIGS. 5 and 6, for the mode of the upper magnetic motion assembly 3 and the lower magnetic motion assembly 2 being magnetically repulsive, the end of the second terminal connector 13 with the positioning contact 131 is located below the spring plate 14. Therefore, when the coil set 200 is unpowered, the movable iron core 300 does not move, and the upper magnetic motion assembly 3 and the lower magnetic motion assembly 2 are the closest, resulting in maximum repulsive force. According, the lower magnetic motion assembly 2 pushes against the spring plate 14, causing the end of the spring plate 14 with the movable contact 141 to deform elastically into an energy-storing state and contact the positioning contact 131 of the second terminal connector 13, resulting in a closed state (FIG. 5).

Referring to FIG. 6, when current enters the coil set 200, an electromagnetic field is generated, driving the movable iron core 300 to move upward along with the upper magnetic motion assembly 3. With the movement of the upper magnetic motion assembly 3, the distance from the lower magnetic motion assembly 2 increases. The increase in the distance causes decreased magnetic repulsive force. At this time, the elastic restoring force of the spring plate 14 gradually becomes greater than the repulsive force, so that the end of the spring plate 14 with the movable contact 141 can elastically recover to release contact with the positioning contact 131, resulting in an open state (FIG. 6).

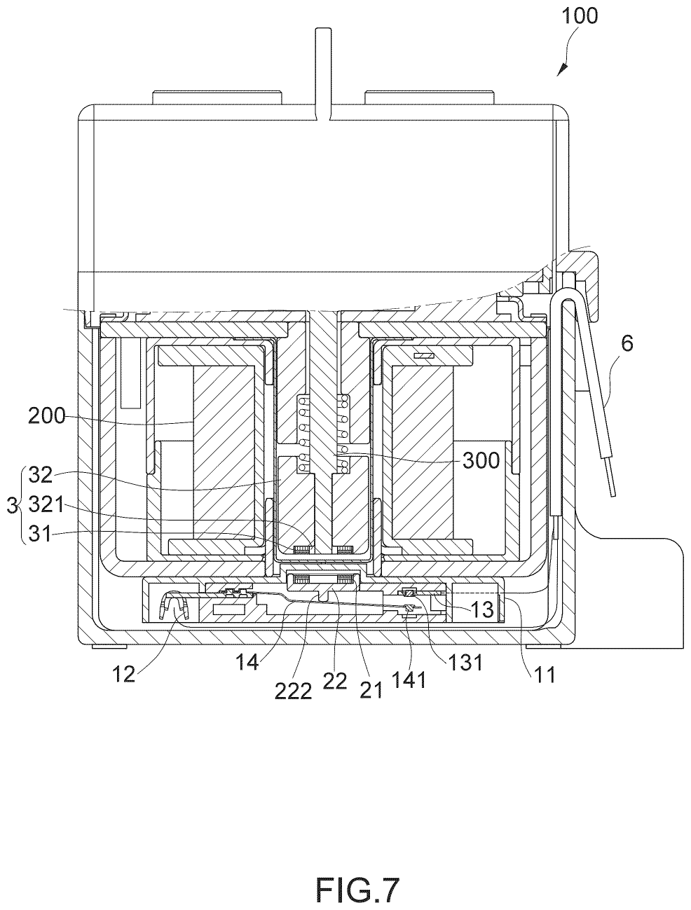

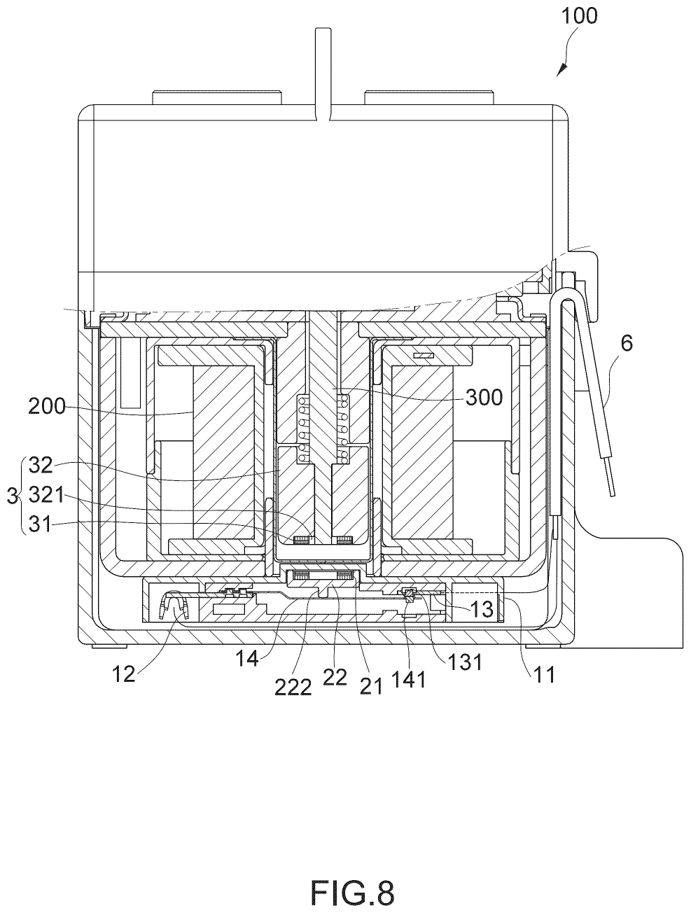

In the repulsion configuration of the upper magnetic motion assembly 3 and the lower magnetic motion assembly 2, instead of the arrangement shown in FIGS. 5 and 6 where the end of the second terminal connector 13 with the positioning contact 131 is located below the spring plate 14, the end of the second terminal connector 13 with the positioning contact 131 may be located above the spring plate 14 for different types of relays 100, as shown in the second embodiment corresponding to FIGS. 7 and 8. In the second embodiment, the action of the spring plate 14 will be opposite to that in the first embodiment. In brief, when the coil set 200 is unpowered with no motion of the movable iron core 300 and the upper magnetic motion assembly 3, the maximum repulsive force, due to the minimum distance between the upper magnetic motion assembly 3 and the lower magnetic motion assembly 2, causes the end of the spring plate 14 with the movable contact 141 to deform elastically and move away from the positioning contact 131 of the second terminal connector 13 (as shown in FIG. 7). Conversely, when the coil set 200 is powered and drives upward motion of the movable iron core 300 and the upper magnetic motion assembly 3, the distance between the upper magnetic motion assembly 3 and the lower magnetic motion assembly 2 increases, resulting in decrease of the repulsive force. When the elastic restoring force of the spring plate 14 exceeds the repulsive force, the end of the spring plate 14 with the movable contact 141 will elastically return and contact the positioning contact 131 of the second terminal connector 13 (as shown in FIG. 8). It can be appreciated that different relays 100 are operated in different manners.

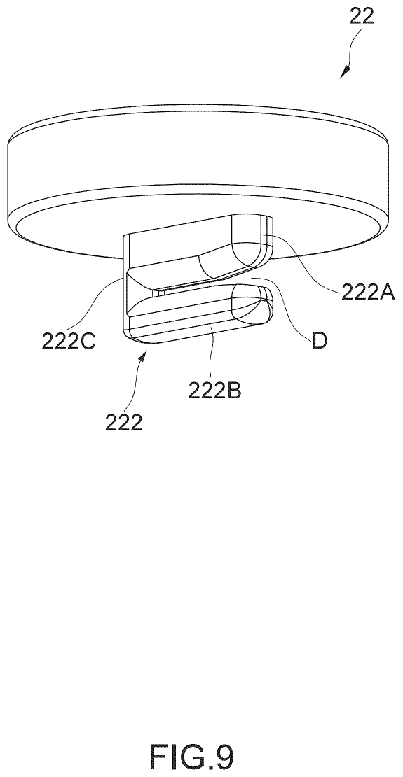

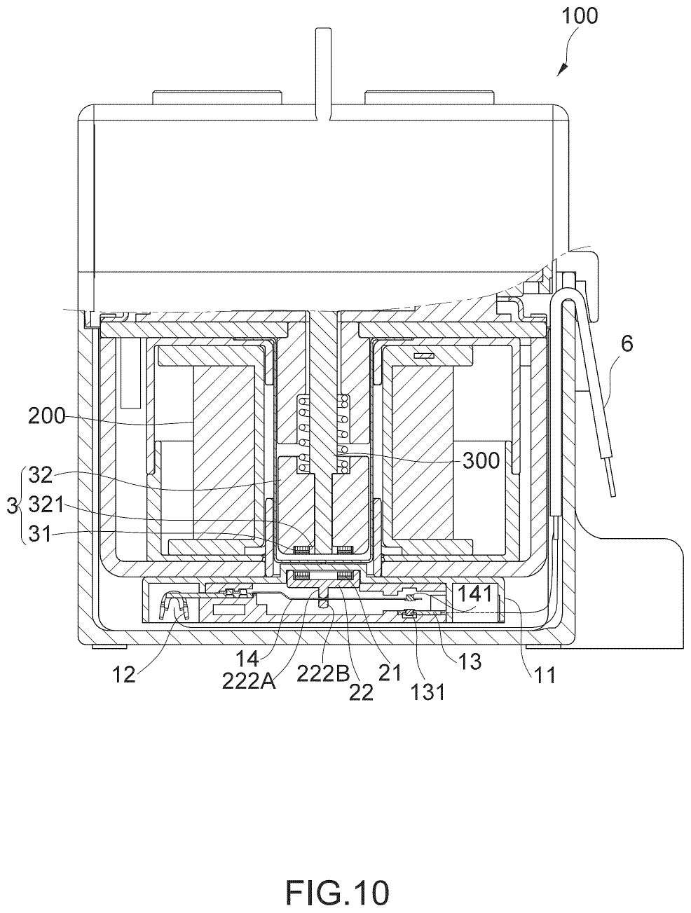

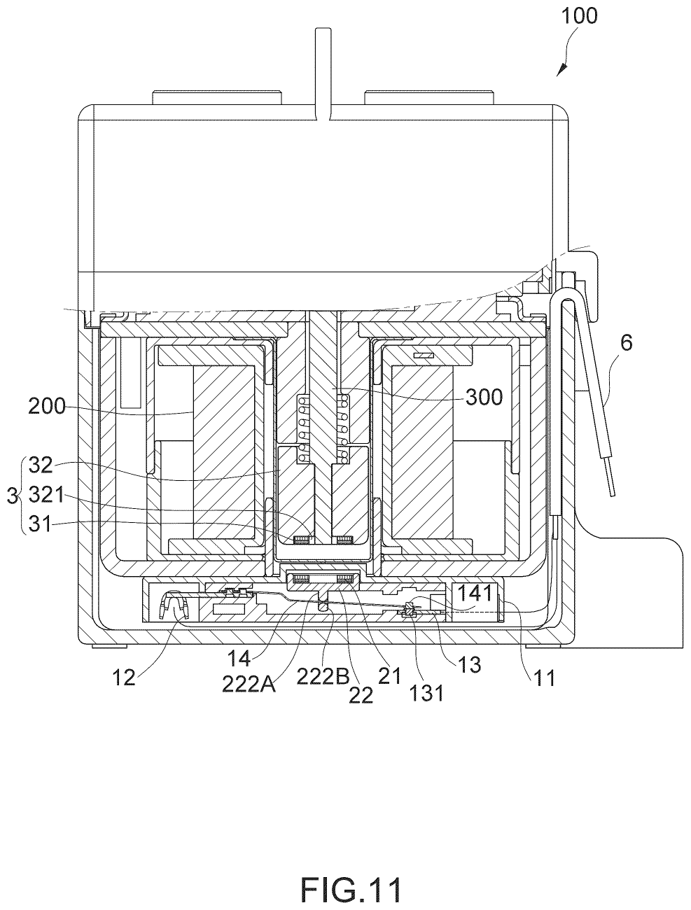

The above description is directed to the upper magnetic motion assembly 3 and the lower magnetic motion assembly 2 in repulsion configuration. Hereafter, the implementation for attraction configuration is illustrated, in which the lower magnetic motion assembly 2 will be fixed with the spring plate 14, or a bump 222 of a lower bracket 22 is modified, as shown in FIG. 9. The bump 222 includes an upper protrusion 222A, a lower protrusion 222B, and a connecting portion 222C connecting the upper protrusion 222A with the lower protrusion 222B. A clamping gap D is formed between the upper protrusion 222A, the lower protrusion 222B, and the connecting portion 222C. The spring plate 14 is clamped within the clamping gap D. When the coil set 200 is in an unpowered state with no motion of the movable iron core 300, the distance between the upper magnetic motion assembly 3 and the lower magnetic motion assembly 2 is minimum, resulting in maximum attractive force. Therefore, the lower magnetic motion assembly 2 will drive the end of the spring plate 14 with the movable contact 141 to move away from the positioning contact 131 therebelow. With the movement, the spring plate 14 will deform elastically and store energy (FIG. 10). On the contrary, when the coil set 200 is powered, the movable iron core 300 moves upward, causing displacement of the upper magnetic motion assembly 3 and, consequently, increasing the distance from the lower magnetic motion assembly 2. At this time, the increase in distance weakens the attractive force. When the elastic restoring force of the spring plate 14 becomes greater than the attractive force, the end of the spring plate 14 with the movable contact 141 can elastically returns and contacts the positioning contact 131 therebelow (FIG. 11).

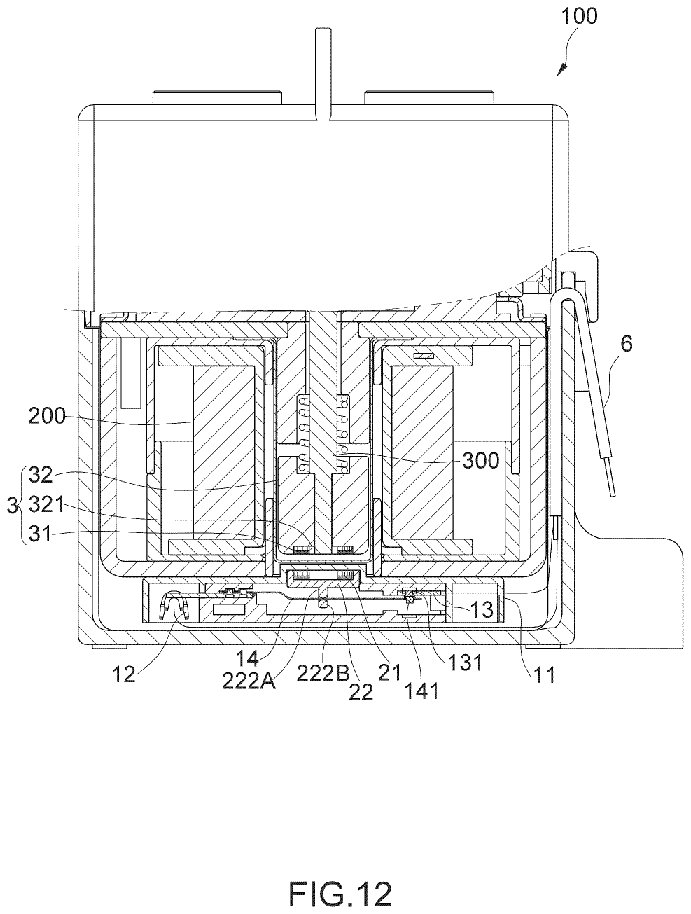

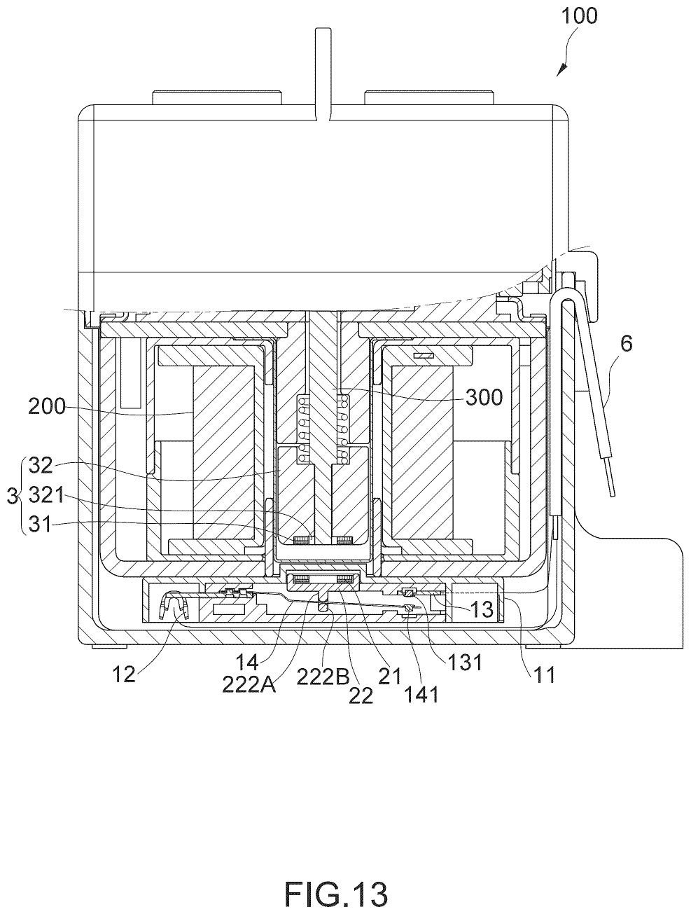

In the instance where the upper magnetic motion assembly 3 and the lower magnetic motion assembly 2 are designed with the same polarity and in attraction configuration, when the coil set 200 is in an unpowered state with no motion of the movable iron core 300 and the upper magnetic motion assembly 3, the maximum attraction force, caused by the minimum distance between the lower magnetic motion assembly 2 and the upper magnetic motion assembly 3, allows the lower magnetic motion assembly 2 to pull and deform the spring plate 14 into an energy-saving state. This results in contact between the end of the spring plate 14 with the movable contact 141 and the end of the second terminal connector 13 with the positioning contact 131 (FIG. 12). Conversely, when the coil set 200 starts to be powered and the movable iron core 300 drives the upper magnetic motion assembly 3 to move upward, the distance between the upper magnetic motion assembly 3 and the lower magnetic motion assembly 2 increases, resulting in decrease in the attraction force. At this time, the restoring energy of the spring plate 14 is greater than the attraction force, so that the spring plate 14 can elastically return and control the movable contact 141 to move away from the positioning contact 131 (FIG. 13).

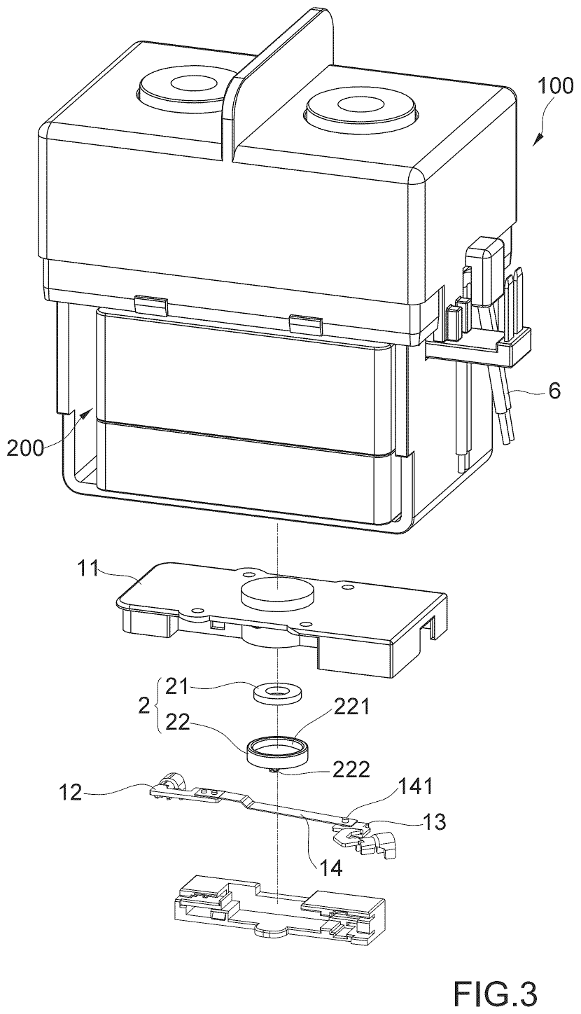

Referring to FIGS. 3 to 6, in accordance with the above description for the operation of the lower magnetic motion assembly 2, the lower magnetic motion assembly 2 includes a lower magnet 21 and a lower bracket 22. The lower bracket 22 is further provided with a mounting groove 221 and a bump 222 respectively at opposite ends. The lower magnet 21 is installed inside the mounting groove 221. The upper magnetic motion assembly 3 includes an upper magnet 31 and a movable seat 32. The movable seat 32 is sleeved around the end of the movable iron core 300, and has one end corresponding to the lower magnetic motion assembly 2 and provided with a mounting slot 321. The upper magnet 31 is installed inside the mounting slot 321. Therefore, when the coil set 200 is in an unpowered state with no motion of the movable iron core 300, the distance between the upper magnet 31 and the lower magnet 21 is minimum, resulting in the maximum attraction or repulsion force. In the repulsion configuration, this causes the bump 222 of the lower bracket 22 to push against and deform the spring plate 14 into an energy-saving state. Instead, in the attraction configuration where the bump 222 is connected to the spring plate 14, the lower bracket 22 pulls the spring plate 14 into a state of deformation and energy storage. Conversely, when the coil set 200 starts to be powered and causes motion of the movable iron core 300, the movable iron core 300 will drive the entire upper magnetic motion assembly 3. As a result, the upper magnet 31 of the upper magnetic motion assembly 3 moves away from the lower magnet 21. When the distance increases, regardless of whether the upper magnet 31 and the lower magnet 21 are in repulsion or attraction configuration, the force will decrease due to the increase in distance. Once the restoring force of the spring plate 14 exceeds the attraction or repulsion force, the spring plate 14 can elastically return and achieve the switching operation.

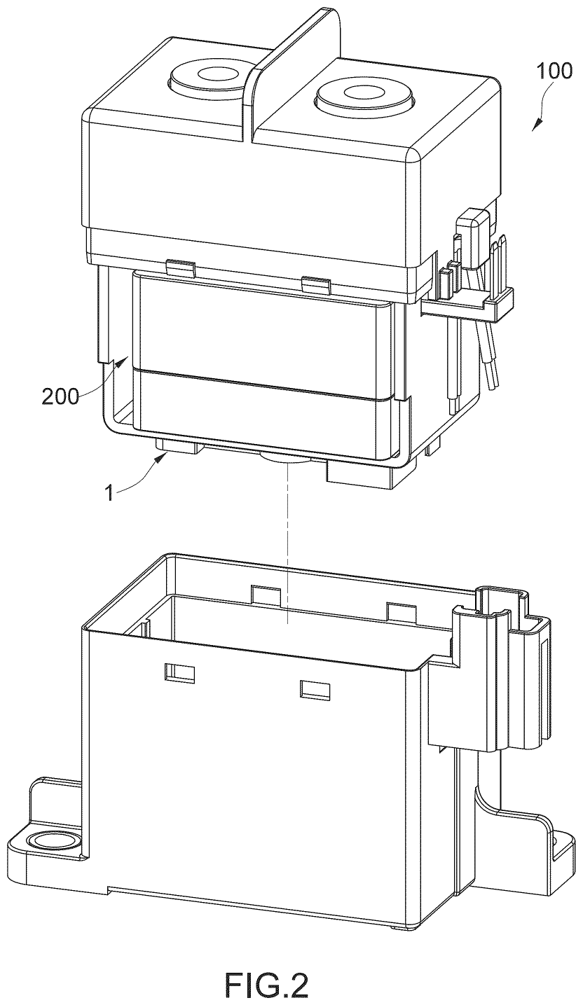

Finally, as shown in FIGS. 2, 3 and 5, a signal terminal 6 is disposed within the side of the relay 100 provided with the coil set 200. The signal terminal 6 has one end electrically connected to the first terminal connector 12 and the second terminal connector 13, and the other end connected to an external detection device (not shown in the figure). The main function of the signal terminal 6 is to enable the detection device to detect the connection and disconnection between the first terminal connector 12 and the second terminal connector 13. During inspection, the signal terminal 6 serves as the signal transmission medium between the detection device and the relay 100, allowing clear detection of whether the operation of the spring plate 14 between the first terminal connector 12 and the second terminal connector 13 is normal under powered and unpowered conditions of the relay 100, thereby improving the yield of the relay 100 in production.

What is claimed is:

1. A magnetically operated switch structure for a delay, the magnetically operated switch structure configured to be installed inside the delay and adjacent to a coil set, into which a movable iron core is inserted, and comprising:
a switch assembly, that corresponds to one end of the movable iron core inserted into the coil set and is located below the coil set;
a lower magnetic motion assembly, that is located between the switch assembly and the movable iron core and connected to the switch assembly; and
an upper magnetic motion assembly, that is sleeved around one end of the movable iron core, spaced from the lower magnetic motion assembly by a gap and configured to be in magnetic effect with the lower magnetic motion assembly;
wherein, by operation between powered and unpowered states of the coil set, the movable iron core is driven to move up and down, causing displacement of the upper magnetic motion assembly, and the displacement of the upper magnetic motion assembly changes a distance from the lower magnetic motion assembly and causes a variation in a magnetic force between the upper magnetic motion assembly and the lower magnetic motion assembly, thereby controlling opening and closing of the switch assembly.

2. The magnetically operated switch structure for a delay as claimed in claim 1, wherein the switch assembly includes a base, a first terminal connector, a second terminal connector, and a spring plate; the base is installed inside the relay and abuts against a bottom surface of the coil set; a limiting groove is recessed into a bottom surface of the base; the first terminal connector and the second terminal connector are installed at opposite ends of the limiting groove, respectively; the spring plate has one end electrically connected to the first terminal connector and the other end provided with a movable contact configured to make movable contact with a positioning contact of the second terminal connector; and
the positioning contact is located below the movable contact; and
when the coil set is unpowered with no upward motion of the moveable iron core and the upper magnetic motion assembly and the lower magnetic motion assembly are in an magnetic repulsion configuration, an repulsive force greater than an elastic restoring force of the spring plate causes the lower magnetic motion assembly to push against a part of the spring plate and thus allows the end of the spring plate with the movable contact to contact the positioning contact and deform, storing elastic energy; and when the coil set starts to be powered, causing upward motion of the movable iron core and increasing a distance between the upper magnetic motion assembly and the lower magnetic motion assembly, the repulsive force decreases with the increase in the distance so that the contact between the end of the spring plate with the movable contact and the positioning contact is released once the repulsive force becomes smaller than the elastic restoring force of the spring plate.

3. The magnetically operated switch structure for a delay as claimed in claim 1, wherein the switch assembly includes a base, a first terminal connector, a second terminal connector, and a spring plate; the base is installed inside the relay and abuts against a bottom surface of the coil set; a limiting groove is recessed into a bottom surface of the base; the first terminal connector and the second terminal connector are installed at opposite ends of the limiting groove, respectively; the spring plate has one end electrically connected to the first terminal connector and the other end provided with a movable contact configured to make movable contact with a positioning contact of the second terminal connector; and the positioning contact is located below the movable contact; and
when the coil set is unpowered with no upward motion of the moveable iron core and the upper magnetic motion assembly and the lower magnetic motion assembly are in an magnetic repulsion configuration, an repulsive force greater than an elastic restoring force of the spring plate causes the lower magnetic motion assembly push against a part of the spring plate and thus allows the end of the spring plate with the movable contact to move away from the positioning contact and deform, storing elastic energy; and when the coil set starts to be powered, causing upward motion of the movable iron core and increasing a distance between the upper magnetic motion assembly and the lower magnetic motion assembly, the repulsive force decreases with the increase in the distance so that the end of the spring plate with the movable contact is allowed to contact the positioning contact once the repulsive force becomes smaller than the elastic restoring force of the spring plate.

4. The magnetically operated switch structure for a delay as claimed in claim 2, wherein the lower magnetic motion assembly includes a magnet and a lower bracket; the lower bracket is further provided with a mounting groove and a bump respectively at opposite ends; the lower magnet is installed inside the mounting groove; and the bump normally contacts the spring plate.

5. The magnetically operated switch structure for a delay as claimed in claim 3, wherein the lower magnetic motion assembly includes a magnet and a lower bracket; the lower bracket is further provided with a mounting groove and a bump respectively at opposite ends; the lower magnet is installed inside the mounting groove; and the bump normally contacts the spring plate.

6. The magnetically operated switch structure for a delay as claimed in claim 4, wherein the upper magnetic motion assembly includes an upper magnet and a movable seat; the movable seat is sleeved around the end of the movable iron core and has one end corresponding to the lower magnetic motion assembly and provided with a mounting slot; the upper magnet is installed inside the mounting slot; when the coil set is powered, generating electromagnetic field, the movable iron core moves upward and drives movement of the movable seat along therewith; and the movement of the movable seat causes motion of the upper magnet away from the lower magnet, increasing the distance and decreasing the repulsive force.

7. The magnetically operated switch structure for a delay as claimed in claim 5, wherein the upper magnetic motion assembly includes an upper magnet and a movable seat; the movable seat is sleeved around the end of the movable iron core and has one end corresponding to the lower magnetic motion assembly and provided with a mounting slot; the upper magnet is installed inside the mounting slot; when the coil set is powered, generating electromagnetic field, the movable iron core moves upward and drives movement of the movable seat along therewith; and the movement of the movable seat causes motion of the upper magnet away from the lower magnet, increasing the distance and decreasing the repulsive force.
